(19) United States
(12) Patent Application Publication
(10) Pub. No.: US 2019/0108468 A1
(43) Pub. Date: Apr. 11, 2019

(54) METHOD AND APPARATUS TO OPERATE SMART MASS TRANSIT SYSTEMS WITH ON-DEMAND RIDES, DYNAMIC ROUTES AND COORDINATED TRANSFERS

(71) Applicants: KHANH VINH NGUYEN, MILPITAS, CA (US); DARRION VINH NGUYEN, MILPITAS, CA (US)

(72) Inventors: KHANH VINH NGUYEN, MILPITAS, CA (US); DARRION VINH NGUYEN, MILPITAS, CA (US)

(21) Appl. No.: 16/153,704

(22) Filed: Oct. 6, 2018

Related U.S. Application Data
(60) Provisional application No. 62/570,102, filed on Oct. 10, 2017.

(51) Int. Cl. G06Q 10/06; G06Q 50/30; G01C 21/34

(52) U.S. Cl. CPC G06Q 10/06315; G06Q 10/06312; G01C 21/3461; G01C 21/3415; G01C 21/3438; G06Q 50/30

(57) ABSTRACT

The present disclosure generally relates to a new mass transit system in which cooperative transit vehicles follow dynamic routes and flexible schedules and perform coordinated transfers to provide personalized transit trips which are faster, more convenient, and more efficient than traditional public transportation services with fixed routes and rigid schedules. Passengers use rider devices such as a smart phone to request transit trips and receive personalized transit plans including pickup, transfer, and drop off instructions in real time. A transit coordination center continuously tracks transit vehicles and passengers, process trip requests, offers personalized transit plans, calculates dynamic transit routes and transfer points, and sends routing and ride instructions to coordinate transit vehicles and passengers. The new system uses a set of iterative algorithms to compute personalized transit plans, dynamic routes and transfers which optimize passenger travel time, vehicle operating costs, and other factors to provide fast and efficient transportation services.

### TECHNICAL FIELD

The present disclosure generally relates to the field of transportation systems and, more particularly, to mass transit systems which use computers and communication devices to provide faster and more efficient transit services.

### BACKGROUND

This section describes approaches that could be employed, but are not necessarily approaches that have been previously conceived or employed. Hence, unless explicitly specified otherwise, any approaches described in this section are not prior art to the claims in this application, and any approaches described in this section are not admitted to be prior art by inclusion in this section.

Mass transportation systems reduce traffic congestions and air pollutions by operating buses and other vehicles that can carry more passengers with fewer trips than personal cars. However, most mass transportation systems today are based on transit vehicles that run predetermined routes, make fixed stops and follow rigid schedules. Because of their inflexibility, traditional mass transportation systems are often inconvenient, time-consuming, and have limited reaches. Recent ride sharing systems utilize computers and mobile communication devices to provide more flexible, personalized transportation services, but they are only suitable for trips with small numbers of passengers and not for mass transportation of large numbers of passengers.

This disclosure describes a new transportation system which provides fast and efficient mass transit services. The new system uses optimization algorithms to calculate personalized transit plans, dynamic transit routes, and coordinated transfers to minimize passenger travel time, vehicle operating costs, and other costs.

### BRIEF DESCRIPTION OF THE DRAWINGS

To provide a more complete understanding of the present disclosure and advantages thereof, reference is made to the attached drawings, like reference numbers represent like parts, in which:

FIG. 1 illustrates an example transit service area which are divided into multiple transit zones, each of which is associated with a transfer center.

FIG. 2 illustrates an example passenger transit trip which are divided into three ride segments.

FIG. 3 illustrates an example embodiment of a transit algorithm that calculates local transit rides for a transit zone.

FIG. 4 illustrates an example embodiment of a transit algorithm that calculates inter-zone transit rides between transfer centers.

### DESCRIPTION OF EXAMPLE EMBODIMENTS

### Overview

A new mass transportation system which is faster, more convenient, and more efficient than traditional public transit systems is disclosed herein. Instead of static routes, fixed stops, and rigid schedules, transit vehicles in the new system run dynamic routes, make flexible stops, and cooperate among themselves to provide fast, convenient, and efficient transit services. The transit service area is divided into multiple transit zones associated with fixed transfer centers as well as dynamic transit stops. A transit coordination center tracks transit vehicles and passengers in real time and uses a set of algorithms to calculate personalized transit plans for passengers and dynamic routes for transit vehicles, match passengers to transit vehicles, and coordinate passenger pick-up, drop-off, and transfers to provide transit services with minimal passenger travel time, vehicle operating costs, and other costs. Passengers can request personalized transit trips which are convenient, fast, and low costs. The new system can improve public transportations to replace personal driving and fundamentally solve the traffic congestion problems.

### DETAILED DESCRIPTION

A typical embodiment of the new mass transportation system has the following components:

1. Cooperative Transit Vehicles: Transit vehicles (buses, shuttles, and cars) that follow dynamic routes and flexible schedules and perform on-demand passenger pickups and drop-offs. The transit vehicles communicate with the Transit Coordination Center (described below) and cooperate with each other to carry passengers to their destinations. One transit vehicle may pick up a passenger, transport, and then transfer her to another transit vehicle to take her to the destination. A passenger trip may involve a number of transit rides and coordinated transfers. Each transit vehicle has a device that communicates with the Transit Coordination Center to receive routing, pickup, transfer, drop-off and other instructions. Each transit vehicle is also equipped with a Global Positioning Device (GPS) that allows the Transit Coordination Center to track the current location of the vehicle and its passengers. Transit vehicles can be autonomous or driven by human drivers. In the former case, autonomous vehicles can be assigned to a particular zone so that the autonomous software can be trained on the local roads of that zone and specialized to handle routes in that zone. In the latter case, each transit vehicle has a console to show the driver routing information and instructions for passenger pick-ups, transfers, and drop-offs. In some cases, transit vehicles may include vehicles that run fixed routes such as light rail trains.

There are two types of transit vehicles: local transit vehicles which carry passengers within a transit zone and between the transit zone and its Transfer Centers (described below), and transfer vehicles which carry passengers between the Transfer Centers. Typically, the local transit vehicles are smaller vehicles such as cars and shuttles which can pick up and drop off individual passengers, while the transfer vehicles are larger vehicles such as buses or trains which can carry larger groups of passengers.

2. On-Demand Pick-ups and Drop-offs and Just-In-Time Transfers: Instead of making fixed stops at rigid schedules, transit vehicles in the new system can pick up, transfer, and drop-off passengers at flexible locations and time by following real-time instructions from the Transit Coordination Center (described below). Passengers can request a trip between any locations in the service area, and the system will provide an end-to-end personalized transit plan for the trip. Passengers can be picked up and dropped off on demand at their homes or office buildings within a small time window of their choice, and there is no need to take long walks to or from bus stops.

Unlike conventional bus transfers which may have long waits, the new system provides Just-In-Time transfers which are quick and require minimum walking and waiting time. A transfer can be at an ad-hoc location such as a street intersection or at a Transfer Center. A Transfer Center is a facility at a fixed location where passengers exit their transit vehicles and board the next transit vehicles. A Transfer Center can be a large transit terminal with multiple boarding platforms for transit cars and buses or a railway station where passengers transfer from road vehicles to transit trains and vice versa. The Transit Coordination Center computes the optimal transfer plans as parts of the personalized transit plans, so passengers do not have to calculate their own transfers. The Transit Coordination Center coordinates the Just-In-Time transfers by sending transfer instructions such as boarding platforms and boarding time to all parties involved in the transfers: drop-off vehicles, passengers, and pick-up vehicles.

3. Transit Coordination Center: The Transit Coordination Center comprises a set of computers and communication equipment that receive transportation requests from passengers, calculate personalized transit plans and dynamic routes, and match passengers to transit vehicles using the Dynamic Transit Algorithms (described below). The Transit Coordination Center dispatches and controls transit vehicles by sending them routing, pick-up, transfer, and drop-off instructions. The Transit Coordination Center collects real-time information about transit trips, passengers' locations, vehicles' status and their current routes, and use these pieces of information as inputs to the Dynamic Transit Algorithms. The Transit Coordination Center then uses the outputs of the Dynamic Transit Algorithms to send instructions to transit vehicles and passengers. The Transit Coordination Center runs the Dynamic Transit Algorithms iteratively to adapt to changing traffic patterns and unexpected situations such as traffic delays, broken vehicles, no-show passengers, and adjust the dynamic routes and transfer plans accordingly in real time.

4. Rider Devices: Passengers use rider devices to request transportations and receive pick-up, drop-off and transfer instructions. A rider device can be a mobile smart phone, a personal computer, or a stationary device at a transit station that passengers can swipe their transit cards to request transit trips. Users can use the rider devices to request a pick-up at their homes, offices, or their current locations anywhere in the service area. In the latter case, the rider device may be equipped with a GPS receiver that allows the system to track the current location of the riders. Passengers also use the rider devices to enter their destination addresses. The rider devices send the trip requests to the Transit Coordination Center and receive offers for personalized transit plans including pickup time, transfer time and locations, and estimated time of arrival (ETA). In some cases, the Transit Coordination Center may offer a counter proposal which ask a passenger to take an alternative pickup or drop-off location in exchange for a faster trip and/or a reduced fare. If the passenger accepts an offer, the rider device sends the acceptance to the Transit Coordination Center and receives trip confirmation and instructions from the Transit Coordination Center. When the passenger arrives at a pickup or transfer point, the rider device guides her to get to the next transit vehicle to continue her trips. For example, at a large Transit Center, the passenger can receive information about the next transit vehicle that she is supposed to board, including the vehicle identification number, boarding time and platform number. The rider device may communicate directly with the transit vehicles to detect and confirm passenger boarding and exiting the vehicles.

5. Dynamic Transit Algorithms: The Transit Coordination Center runs the Dynamic Transit Algorithms to process passenger trip requests, create personalized transit plans by dividing transit trips into ride segments, calculate dynamic routes for transit vehicles to handle the ride segments, and send routing, pick-up, drop-off, and transfer instructions to transit vehicles and passengers in real time. The following sections will describe an example embodiment of the Dynamic Transit Algorithms.

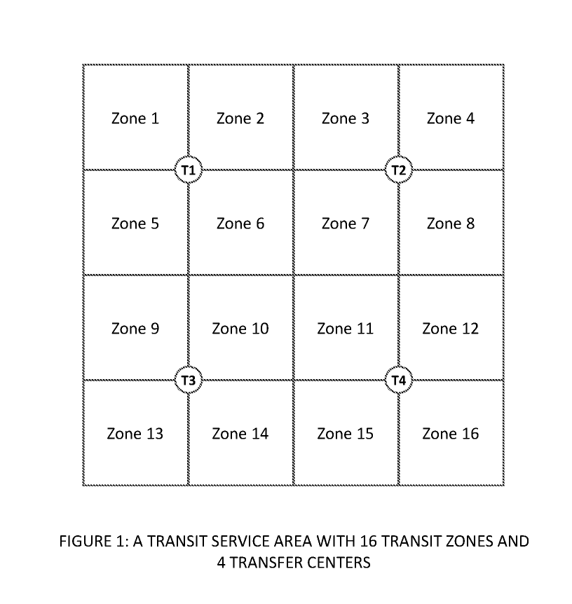

First, the transit service area is divided into a number of transit zones. The sizes and boundaries of the transit zones can be static or dynamic. In the latter case, the size and boundary of a zone can change to adapt to transit demands and traffic conditions according to some optimization algorithms. FIG. 1 illustrates an example service area which is divided into 16 transit zones.

Each transit zone is associated with one or multiple Transfer Centers which serve as its primary transfer points for inter-zone trips. A Transfer Center can serve one or multiple transit zones. A transit zone is usually associated with the nearest Transfer Center, but other optimization criteria can be used to associate a transit zone to multiple Transfer Centers. FIG. 1 illustrates an example service area with 4 Transfer Centers, each of which is associated with 4 transit zones.

At any given time, each transit zone is allocated a fleet of local transit vehicles to handle the passenger rides for that zone. The assignments of vehicles to the local transit fleets can be dynamic as vehicles can be reassigned from one fleet to another according to the transit demand in each zones.

Similarly, at any given time, the Transfer Centers are allocated a fleet of transfer vehicles which carry passengers between the Transfer Centers. The assignments of transit vehicles to the transfer fleet can be dynamic as vehicles can be added to or removed from the fleet.

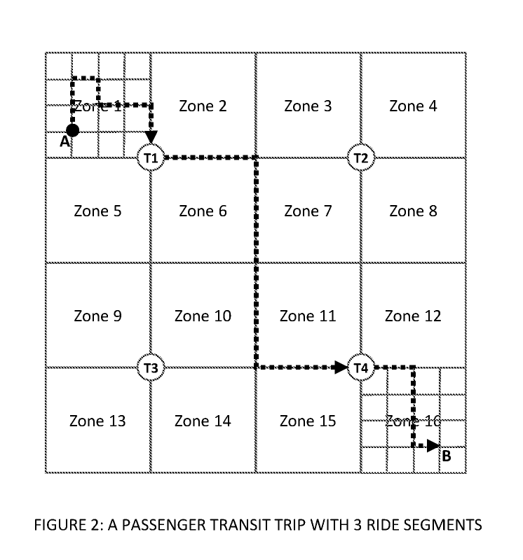

To create the personalized transit plans, the Dynamic Transit Algorithms divide each passenger trip into one or multiple ride segments depending on the trip's starting and destination transit zones. In the following paragraphs, the terms “ride segment” and “ride” are used interchangeably. FIG. 2 illustrates an example passenger trip from A to B which is segmented into 3 rides. In the first ride, a local transit vehicle from Zone 1 carries the passenger from the pick-up point A in Zone 1 to Transfer Center T1 associated with Zone 1. In the second ride, a transfer vehicle carries the passenger from Transfer Center T1 to Transfer Center T4. In the third ride, a local transit vehicle from Zone 16 carries the passenger from Transfer Center T4 to the destination B in Zone 16.

In general, if a passenger trip is within a transit zone, then only one local ride segment is needed. Otherwise, if a passenger trip is across multiple zones, the trip is segmented into two or more rides. If a trip's starting zone and destination zone are associated with a common Transfer Center, then the Dynamic Transit Algorithms segment the trip into two transit rides: from the pick-up point in the starting zone to the Transfer Center, and from the Transfer Center to the drop-off point in the destination zone. If the trip's starting zone and destination zone are associated with different Transfer Centers, then the Dynamic Transit Algorithms segment the passenger trip into three rides: from the starting zone to the starting zone's Transfer Center, from the starting zone's Transfer Center to the destination zone's Transfer Center, and from the destination zone's Transfer Center to the destination zone. In some cases, the ride segments can be further segmented or combined together for optimization. In general, rides to or from a transit zone are handled by the local transit fleet associated with that zone, and rides between Transfer Centers are handled by the transfer fleet.

The Dynamic Transit Algorithms include the Local Transit Algorithm, which calculates the dynamic routes for the local transit fleets, and the Inter-Zone Transfer Algorithm, which calculates the dynamic routes for the transfer fleet.

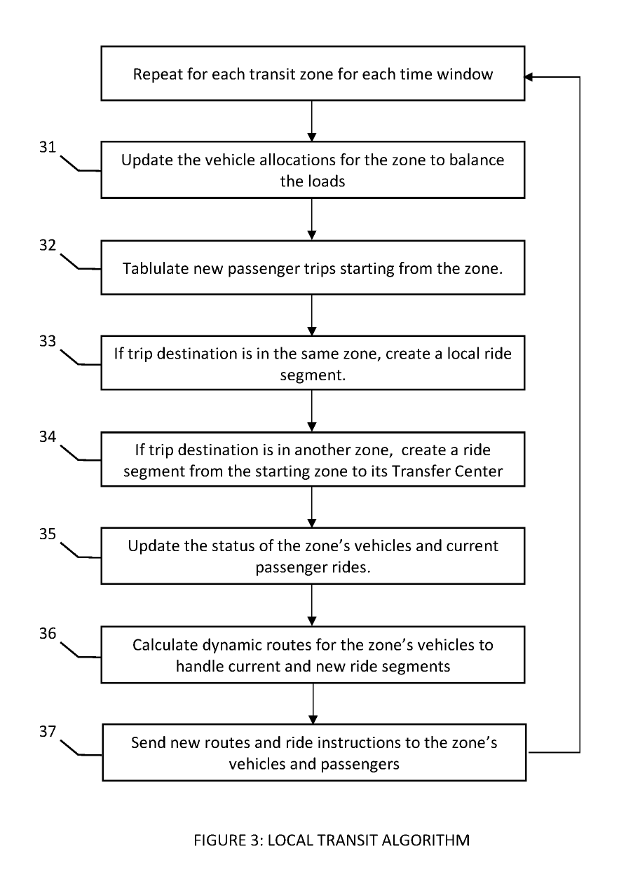

FIG. 3 illustrates an example embodiment of the Local Transit Algorithm which calculates the dynamic routes for a local transit fleet to handle the passenger rides within a transit zone and between the zone and its Transfer Center. The algorithm is based on iterative time windows. The interval of each time window can vary from seconds to minutes. For each time window, the algorithm runs a number of steps for each transit zone. In step 31, the algorithm updates the vehicle allocations for the transit zone by reassigning vehicles to or from other zones to balance the loads of the system. In step 32, the algorithm tabulates all new passenger trips which are scheduled to start from the zone during the time window. In step 33, if the destination of a new trip is in the same transit zone, then the algorithm creates a local ride segment within the transit zone for that trip. In step 34, if the destination of a new trip is in another zone, then the algorithm creates a ride segment from the starting point in the transit zone to its Transfer Center. In step 35, the algorithm collects the latest status of the zone's vehicles and passengers, including their locations, and updates the current rides of the transit zone. In step 36, the algorithm uses the Shortest Path Algorithm, the Travelling Salesman Algorithm, Dynamic Programming, Artificial Neural Networks, or other optimization methods to calculate the optimal (or near optimal) dynamic routes for the zone's local transit fleet to handle the new ride segments created in steps 33 and 34 as well as the existing rides from step 35. Each local transit vehicle can handle multiple passenger rides in one route. The optimal routes are selected based on the criterion of minimizing a cost function which includes passenger wait time, travel time, vehicle mileages, fuel consumptions, and other factors. In step 37, the algorithm sends the updated routes and ride instructions to the local transit vehicles and the passengers.

The Local Transit Algorithm can sub-divide some ride segments into shorter segments if doing so reduce the cost function. In such cases, passengers may be transferred between ride segments at dynamic, ad-hoc stops instead of a Transfer Center. For example, two transit vehicles going to different directions may do a Just-In-Time transfer to exchange their passengers when they cross each other. At the crossing point, vehicle A may transfer a passenger heading to destination X to vehicle B if B is heading to the same destination X. Such Just-In-Time transfer is fast because it requires little or no passenger walking and waiting time.

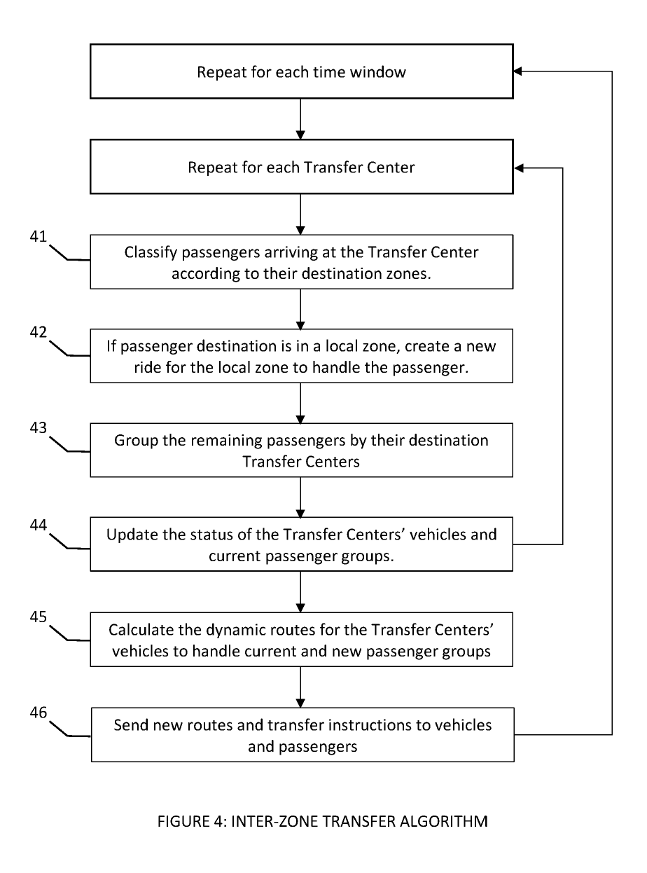

FIG. 4 illustrates an example embodiment of the Inter-Zone Transfer Algorithm which calculates the dynamic routes for the transfer fleet to handles passenger rides between the Transfer Centers. The algorithm is based on iterative time windows. The interval of each time window can vary from seconds to minutes. For each time window, the algorithm will run a number of steps. In step 41, the algorithm classifies the passengers arriving at each Transfer Center during the time window according to their destination transit zones. In step 42, if the destination zone of a passenger is a local transit zone which is associated with the Transfer Center, then the algorithm creates a new ride segment for the local transit fleet of the destination zone to take the passenger from the Transfer Center to the destination zone. Otherwise, in step 43, the algorithm groups the remaining passengers by the Transfer Centers of their destination zones. Passengers travelling between the same Transfer Centers will be in the same groups. In step 44, the algorithm collects and updates the latest status of the transfer vehicles and their current passenger groups. In step 45, the algorithm uses the Shortest Path Algorithm, the Travelling Salesman algorithm, Dynamic Programming, Artificial Neural Networks, or other optimization methods to calculate the optimal (or near optimal) dynamic routes for the transfer vehicles to handle the new passenger groups created in step 43 as well as existing passenger groups from step 44. Each transfer vehicle can handle multiple passenger groups in one route. The optimal routes are selected based on the criterion of minimizing a cost function which includes passenger wait time, travel time, vehicle mileages, fuel consumptions, and other factors. In step 46, the algorithm sends the updated routes and ride instructions to the transfer vehicles and the passengers.

The cost functions used in the above algorithms may include the worst passenger wait time and travel time to avoid starvation problems. The cost function may also include other factors such as driver labor costs, emergency, pricing differentiations, etc. These factors can be combined using some weighted summation. Methods such as Artificial Neural Network and Gradient Descent can be used to find the optimal (or near optimal) ride segmentations and dynamic routes that minimize the cost function.

The price of a personalized transit trip can be calculated based on the marginal increments of the cost functions to handle the new trip. For example, requesting a pick-up location in the path of an existing route can be priced less than the one that requires a new route or a new vehicle to be dispatched. Passengers can choose to pay extra fare to receive premium services that provide faster trips. The system can adjust the cost function to add more weight to the travel time of the premium passengers to create service differentiators. For example, a route with premium passengers may have fewer stops than normal because of the biased cost function. When a passenger makes a trip request, the system can offer multiple personalized transit plans with different prices. For example, the system can offer alternative pick up or drop off locations. The passenger may be asked to walk a short distance to the pick-up point in exchange for a reduced fare or a faster pickup.

The new mass transit system provides many advantages compared to traditional transit systems. By using dynamic routes, flexible stops, and Just-In-Time transfers, the new system reduces passenger travel time and wait time. Passenger grouping at the Transfer Centers increases transportation efficiency. Compared to ride sharing systems, the new mass transit system requires fewer vehicle routes to handle the same number of passenger trips. For example, for the transit service area in FIG. 1 which has N=16 transit zones and M=4 Transfer Centers, a ride sharing system may need N²=256 vehicle routes to handle all combinations of passenger trips between pairs of zones. To serve the same combinations of passenger trips, the new system needs only N+M(M−1)+N=44 vehicle routes: N=16 routes to carry passengers from N starting zones to the Transfer Centers, M(M−1)=12 routes to carry passengers between all pairs of Transfer Centers, and N=16 routes to carry passengers from the Transfer Centers to the destination zones.

What is claimed is:

1. A method of mass transportation comprising:
operating transit vehicles which follow dynamic routes and flexible schedules and cooperate with other transit vehicles to carry passengers;
operating transfer centers and dynamic transit stops for on-demand pick-ups, drop-offs and coordinated transfers;
utilizing rider devices to allow the passengers to request transit trips and receive personalized transit plans and ride instructions; and
running transit algorithms which compute the personalized transit plans and the dynamic routes, match the passengers to the transit vehicles, and coordinate transit rides and transfers.

2. The method of claim 1, wherein a transit service area is divided into multiple transit zones whose sizes and boundaries are determined according to some optimization method which minimizes a cost function.

3. The method of claim 1, wherein the transit vehicles are assigned to local transit fleets each of which carry passengers for a particular transit zone, and a transfer fleet which carry passengers between the transfer centers, according to some optimization method which minimizes a cost function.

4. The method of claim 1, wherein the passengers use the rider devices to request the transit trips, receive offers for the personalized transit plans with different pick-up, drop-off and other options at different prices, accept offers, and receive the ride instructions including pick-up, drop-off, and transfer time and locations.

5. The method of claim 1, wherein the transit algorithms create the personalized transit plans by segmenting each transit trip into one or multiple transit rides, which can include transit rides within a transit zone, between a transit zone and a transfer center, and between transfer centers, based on some optimization method which minimizes a cost function.

6. The method of claim 1, wherein the passengers arriving at a transfer center are grouped according to their destinations, and the passenger groups are assigned to the next transit vehicles according to some optimization methods which minimizes a cost function.

7. The method of claim 1, wherein the time and locations of the dynamic transit stops for on-demand pick-ups, drop-offs, and coordinated transfers are determined dynamically, based on some optimization method which minimizes a cost function.

8. The method of claim 1, wherein the transit algorithms include an iterative algorithm which calculates the dynamic routes for each local transit fleet to handle the transit rides within a particular transit zone and between the transit zone and its associated transfer centers, based on some optimization method which minimizes a cost function associated with the transit zone.

9. The method of claim 1, wherein the transit algorithms include an iterative algorithm which calculates the dynamic routes for the transfer fleet to handle the transit rides between transfer centers, based on some optimization method which minimizes a cost function associated with the transfer centers.

10. The method of claims 2, 3, 5, 6, 7, 8, and 9, wherein the cost function is a weighted sum of multiple factors including passenger travel time, vehicle operating costs, and other factors.

11. The method of claims 2 and 3, wherein the cost function is a global cost function which is a summation of the cost functions associated with the transit zones and the transfer centers.

12. The method of claim 4, wherein the prices of the offers are calculated based on the marginal increments of the cost functions to handle the offered personalized transit plans, and the passengers can choose to pay higher prices in exchange for faster or more convenient trips.

13. An apparatus of mass transit comprising:
transit vehicles which follow dynamic routes and flexible schedules and cooperate with other transit vehicles to carry passengers;
transfer centers and dynamic transit stops for on-demand pick-ups, drop-offs and coordinated transfers;
rider devices which allow the passengers to request transit trips and receive personalized transit plans and ride instructions; and
a transit coordination center which runs transit algorithms to compute the personalized transit plans and the dynamic routes, match the passengers to the transit vehicles, and coordinate transit rides and transfers.

14. The apparatus of claim 13, wherein a transit service area is divided into multiple transit zones whose sizes and boundaries are determined according to some optimization method which minimizes a cost function.

15. The apparatus of claim 13, wherein the transit vehicles are assigned to local transit fleets each of which carry passengers for a particular transit zone, and a transfer fleet which carry passengers between the transfer centers, according to some optimization method which minimizes a cost function.

16. The apparatus of claim 13, wherein the passengers use the rider devices to request the transit trips, receive offers for the personalized transit plans with different pick-up, drop-off and other options at different prices, accept offers, and receive the ride instructions including pick-up, drop-off, and transfer time and locations.

17. The apparatus of claim 13, wherein the transit algorithms create the personalized transit plans by segmenting each transit trip into one or multiple transit rides, which can include transit rides within a transit zone, between a transit zone and a transfer center, and between transfer centers, based on some optimization method which minimizes a cost function.

18. The apparatus of claim 13, wherein the passengers arriving at a transfer center are grouped according to their destinations, and the passenger groups are assigned to the next transit vehicles according to some optimization methods which minimizes a cost function.

19. The apparatus of claim 13, wherein the time and locations of the dynamic transit stops for on-demand pick-ups, drop-offs, and coordinated transfers are determined dynamically, based on some optimization method which minimizes a cost function.

20. The apparatus of claim 13, wherein the transit algorithms include an iterative algorithm which calculates the dynamic routes for each local transit fleet to handle the transit rides within a particular transit zone and between the transit zone and its associated transfer centers, based on some optimization method which minimizes a cost function associated with the transit zone.

21. The apparatus of claim 13, wherein the transit algorithms include an iterative algorithm which calculates the dynamic routes for the transfer fleet to handle the transit rides between transfer centers, based on some optimization method which minimizes a cost function associated with the transfer centers.

22. The apparatus of claims 14, 15, 17, 18, 19, 20, and 21, wherein the cost function is a weighted sum of multiple factors including passenger travel time, vehicle operating costs, and other factors.

23. The apparatus of claims 14 and 15, wherein the cost function is a global cost function which is a summation of the cost functions associated with the transit zones and the transfer centers.

24. The apparatus of claim 16, wherein the prices of the offers are calculated based on the marginal increments of the cost functions to handle the offered personalized transit plans, and the passengers can choose to pay higher prices in exchange for faster or more convenient trips.
